(19) United States
(12) Patent Application Publication
(10) Pub. No.: US 2013/0088165 A1
(43) Pub. Date: Apr. 11, 2013

(54) LIGHT-EMITTING COMPONENT DRIVING CIRCUIT AND RELATED PIXEL CIRCUIT AND APPLICATIONS USING THE SAME

(71) Applicants: Wen-Chun Wang, Taichung City (TW); Hsi-Rong Han, Taichung City (TW); Wen-Tui Liao, Taichung City (TW); Chih-Hung Huang, Taichung City (TW); Tsung-Yu Wang, Taichung City (TW)

(72) Inventors: Wen-Chun Wang, Taichung City (TW); Hsi-Rong Han, Taichung City (TW); Wen-Tui Liao, Taichung City (TW); Chih-Hung Huang, Taichung City (TW); Tsung-Yu Wang, Taichung City (TW)

(21) Appl. No.: 13/645,505

(22) Filed: Oct. 4, 2012

(30) Foreign Application Priority Data
Oct. 5, 2011 (TW) 100135995
Feb. 10, 2012 (TW) 101104422

(51) Int. Cl. H05B 37/02

(52) U.S. Cl. 315/240

(57) ABSTRACT

An organic light-emitting diode (OLED) pixel circuit is provided, and if a circuit configuration (5T1C) thereof collocates with suitable operation waveforms, a current flowing through an OLED in the OLED pixel circuit may not be changed along with the power supply voltage (Vdd) which may be influenced by an IR drop, and may not be varied along with the threshold voltage (Vth) shift of a thin film transistor used for driving the OLED. Accordingly, the brightness uniformity of the applied OLED display can be substantially improved.

### CROSS-REFERENCE TO RELATED APPLICATION

This application claims the priority benefits of Taiwan application serial no. 100135995, filed on Oct. 5, 2011, and Taiwan application serial no. 101104422, filed on Feb. 10, 2012. The entirety of each of the above-mentioned patent applications is hereby incorporated by reference herein and made a part of specification.

### BACKGROUND OF THE INVENTION

1. Field of the Invention

The invention relates to a flat panel display technique. Particularly, the invention relates to a light-emitting component (for example, OLED) driving circuit and a related pixel circuit and applications using the same.

2. Description of Related Art

With rapid progress of multimedia society, techniques of semiconductor devices and display devices are also greatly improved. Regarding the displays, since an active matrix organic light-emitting diode (AMOLED) display has advantages of no viewing-angle limitation, low fabrication cost, high response speed (about a hundred times higher than a liquid crystal display), power saving, self luminous, direct current (DC) driving suitable for portable devices, large working temperature range, light weight, and miniaturization and thinness along with hardware equipment, etc. to cope with feature requirements of displays of the multimedia age, the AMOLED has a great development potential to become a novel planar display of a next generation to replace the liquid crystal displays (LCD).

Presently, there are two methods for fabricating an AMOLED panel, and one is to use a low temperature polysilicon (LTPS) thin film transistor (TFT) process technique for fabrication, and another one is to use an a-Si TFT process technique for fabrication. Since the LTPS TFT process technique requires more optical mask processes to cause a high fabrication cost, the LTPS TFT process technique is mainly used in fabrication of middle and small size panels, and the a-Si TFT process technique is mainly used in fabrication of large size panels.

Generally, in the AMOLED panel fabricated according to the LTPS TFT process technique, a type of a TFT in a pixel circuit thereof can be a P-type or an N-type, and sine the P-type TFT has a better driving capability of conducting a positive voltage, the P-type TFT is generally used for implementation. However, in case that the P-type TFT is used to implement the OLED pixel circuit, a current flowing through the OLED is not only changed along with a power supply voltage (Vdd) which may be influenced by an IR drop, but is also changed along with a threshold voltage (Vth) shift of a TFT used for driving the OLED. Therefore, brightness uniformity of the OLED display is accordingly influenced.

### SUMMARY OF THE INVENTION

Accordingly, an exemplary embodiment of the invention provides a light-emitting component driving circuit including a power unit, a driving unit and a data storage unit. The power unit receives a power supply voltage, and transmits the power supply voltage in response to a light enable signal in a light enable phase. The driving unit is coupled between the power unit and a first end of a light-emitting component, and includes a driving transistor coupled to a first end of the light-emitting component. The driving unit controls a driving current flowing through the light-emitting component in the light enable phase.

The data storage unit includes a storage capacitor, and stores a data voltage (Vdata) and a threshold voltage (Vth) related to the driving transistor through the storage capacitor in a data-writing phase. In the light enable phase, the driving unit generates the driving current flowing through the light-emitting component in response to a cross voltage of the storage capacitor, and the driving current flowing through the light-emitting component is not influenced by the power supply voltage and the threshold voltage of the driving transistor.

In an exemplary embodiment of the invention, a second end of the light-emitting component is coupled to a reference voltage, and in case that the power supply voltage is a variable power supply voltage, the power unit includes a power conduction transistor, where a source thereof receives the variable power supply voltage, and a gate thereof receives the light enable signal.

In an exemplary embodiment of the invention, in case that the power supply voltage is the variable power supply voltage, a first drain/source of the driving transistor is coupled to a drain of the power conduction transistor, a second drain/source of the driving transistor is coupled to the first end of the light-emitting component, and a gate of the driving transistor is coupled to a first end of the storage capacitor. Moreover, a second end of the storage capacitor is coupled to the variable power supply voltage.

In an exemplary embodiment of the invention, in case that the power supply voltage is the variable power supply voltage, the data storage unit further includes a writing transistor and a collection transistor. A gate of the writing transistor receives a writing scan signal, a drain of the writing transistor receives the data voltage, and a source of the writing transistor may be coupled to the second drain/source of the driving transistor and the first end of the light-emitting component (or the source of the writing transistor may be coupled to the first drain/source of the driving transistor and the drain of the power conduction transistor). A gate of the collection transistor receives the writing scan signal, a source of the collection transistor is coupled to the gate of the driving transistor and the first end of the storage capacitor, and a drain of the collection transistor may be coupled to the first drain/source of the driving transistor and the drain of the power conduction transistor (or the drain of the collection transistor may be coupled to the second drain/source of the driving transistor and the first end of the light-emitting component). The light-emitting component is, for example, an organic light-emitting diode, where the first end of the light-emitting component is an anode of the OLED, and the second end of the light-emitting component is a cathode of the OLED. In this case, a level of the reference voltage is substantially not less than a highest level of the data voltage minus a conduction voltage of the OLED (or the level of the reference voltage is substantially not less than the highest level of the data voltage minus the threshold voltage of the driving transistor and the conduction voltage of the OLED). Moreover, the provided light-emitting component driving circuit is an OLED driving circuit.

In an exemplary embodiment of the invention, in case that the power supply voltage is the variable power supply voltage, the data storage unit further initializes the storage capacitor in response to a reset scan signal in a reset phase. In this case, the data storage unit further includes a reset transistor, where a gate and a source thereof are coupled with each other to receive the reset scan signal, and a drain thereof is coupled to the gate of the driving transistor, the source of the collection transistor and the first end of the storage capacitor.

In an exemplary embodiment of the invention, in case that the power supply voltage is the variable power supply voltage, the driving transistor, the power conduction transistor, the writing transistor, the collection transistor and the reset transistor are all P-type transistors.

In an exemplary embodiment of the invention, if the variable power supply voltage is changed to a constant power supply voltage, the first end of the storage capacitor is coupled to the reference voltage before the light enable phase and is coupled to the constant power supply voltage during the light enable phase in response to a switching means.

In an exemplary embodiment of the invention, the second end of the light-emitting component is coupled to a reference voltage, and the power supply voltage can be a constant or a variable power voltage. In this case, the power unit includes a power conduction transistor, where a drain thereof receives the constant or the variable power supply voltage, and a gate thereof receives the light enable signal.

In an exemplary embodiment of the invention, in case that the power supply voltage is the constant or variable power supply voltage, the drain of the driving transistor is coupled to the source of the power conduction transistor, the source of the driving transistor is coupled to the first end of the light-emitting component, and the gate of the driving transistor is coupled to a first end of the storage capacitor. Moreover, a second end of the storage capacitor is coupled to the reference voltage.

In an exemplary embodiment of the invention, in case that the power supply voltage is the constant or variable power supply voltage, the data storage unit further includes a writing transistor and a collection transistor. A gate of the writing transistor receives a writing scan signal, a drain of the writing transistor receives the data voltage, and a source of the writing transistor is coupled to the source of the driving transistor and the first end of the light-emitting component. A gate of the collection transistor receives the writing scan signal, a drain of the collection transistor is coupled to the gate of the driving transistor and the first end of the storage capacitor, and a source of the collection transistor is coupled to the drain of the driving transistor and the source of the power conduction transistor. The light-emitting component is, for example, an organic light-emitting diode, where the first end of the light-emitting component is an anode of the OLED, and the second end of the light-emitting component is a cathode of the OLED. In this case, a level of the reference voltage is substantially not less than a highest level of the data voltage minus a conduction voltage of the OLED.

In an exemplary embodiment of the invention, in case that the power supply voltage is the constant or variable power supply voltage, the data storage unit further initializes the storage capacitor in response to a reset scan signal in a reset phase. In this case, the data storage unit further includes a reset transistor, where a gate and a source thereof are coupled with each other to receive the reset scan signal, and a drain thereof is coupled to the gate of the driving transistor, the drain of the collection transistor and the first end of the storage capacitor.

In an exemplary embodiment of the invention, in case that the power supply voltage is the constant or variable power supply voltage, the driving transistor, the power conduction transistor, the writing transistor, the collection transistor and the reset transistor are all N-type transistors.

In an exemplary embodiment of the invention, the light-emitting component driving circuit is an OLED driving circuit, and the OLED driving circuit sequentially enters the reset phase, the data-writing phase, and the light enable phase.

Another exemplary embodiment of the invention provides an OLED pixel circuit having the aforementioned OLED driving circuit.

Another exemplary embodiment of the invention provides an OLED display panel having the aforementioned OLED pixel circuit.

Another exemplary embodiment of the invention provides an OLED display having the aforementioned OLED display panel.

According to the above descriptions, the invention provides an OLED pixel circuit, and in case that the circuit configuration (5T1C) thereof collocates with suitable operation waveforms, the current flowing through the OLED may not be changed along with the power supply voltage (Vdd) which may be influenced by the IR drop, and may not be varied along with the threshold voltage (Vth) shift of a TFT used for driving the OLED. In this way, the brightness uniformity of the applied OLED display can be substantially improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an organic light-emitting diode (OLED) pixel circuit 10 according to an exemplary embodiment of the invention.

FIG. 2 is a circuit diagram of the OLED pixel circuit 10 of FIG. 1.

FIG. 3 is an operation waveform diagram of the OLED pixel circuit 10 of FIG. 1.

FIG. 4 is another circuit diagram of the OLED pixel circuit 10 of FIG. 1.

FIG. 5 is another circuit diagram of the OLED pixel circuit 10 of FIG. 1.

FIG. 6 is an operation waveform diagram of the OLED pixel circuit 10 of FIG. 5.

FIG. 7 is another circuit diagram of the OLED pixel circuit 10 of FIG. 1.

FIG. 8 is another circuit diagram of the OLED pixel circuit 10 of FIG. 1.

FIG. 9 is an operation waveform diagram of the OLED pixel circuit 10 of FIG. 8.

FIG. 10 is another operation waveform diagram of the OLED pixel circuit 10 of FIG. 8.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

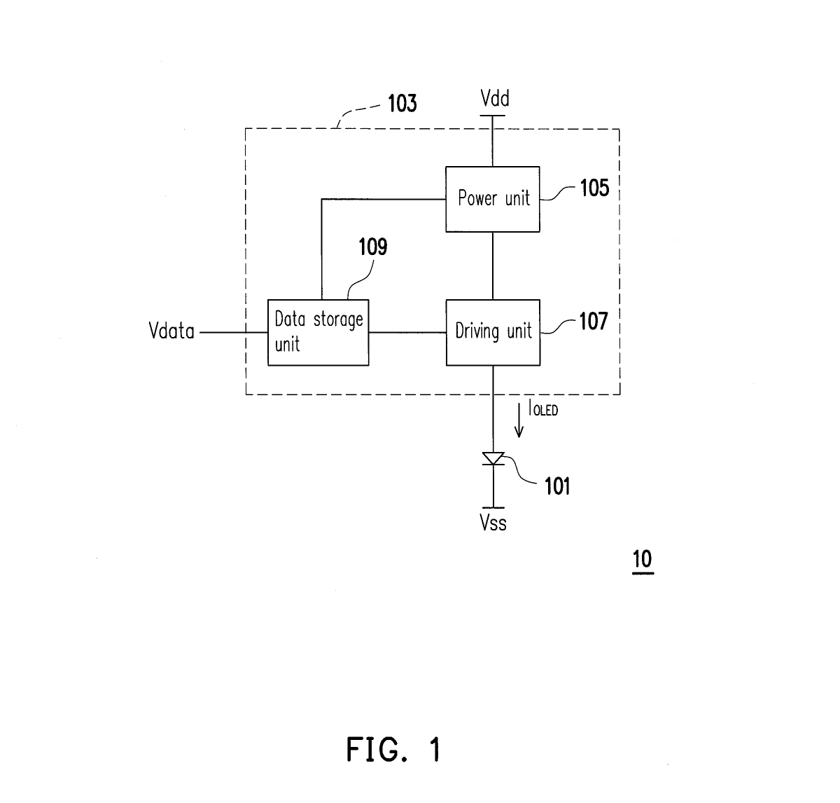

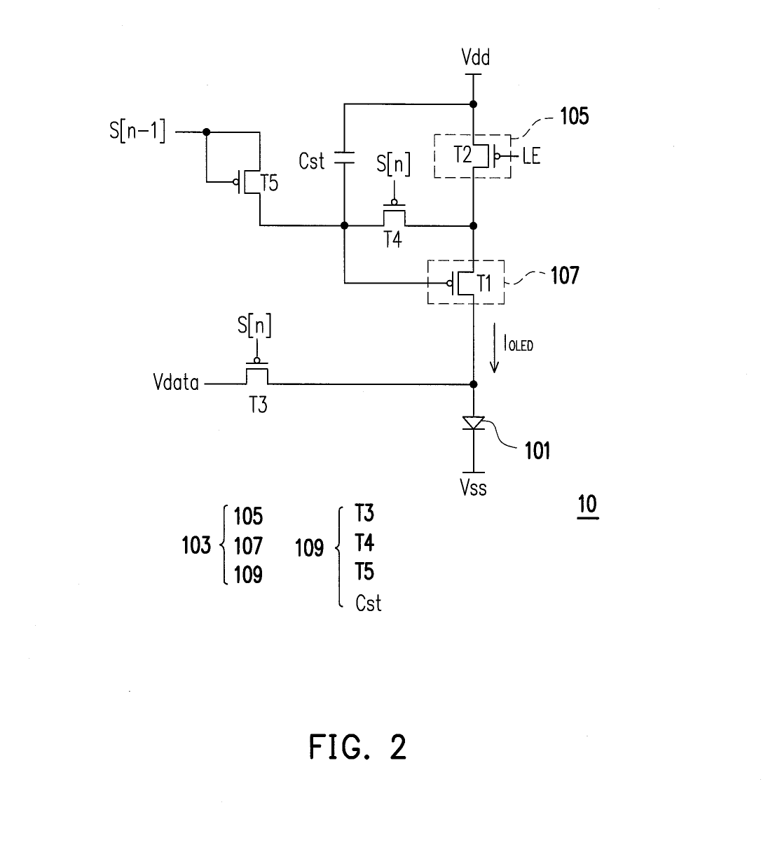

FIG. 1 is a schematic diagram of an organic light-emitting diode (OLED) pixel circuit 10 according to an exemplary embodiment of the invention. FIG. 2 is a circuit diagram of the OLED pixel circuit 10 of FIG. 1. Referring to FIG. 1 and FIG. 2, the OLED pixel circuit 10 of the present exemplary embodiment includes a light-emitting component (for example, an OLED 101, though the invention is not limited thereto) and a light-emitting component driving circuit 103. The light-emitting component driving circuit 103 includes a power unit 105, a driving unit 107 and a data storage unit 109.

In the present exemplary embodiment, the power unit 105 receives a power supply voltage Vdd, and transmits the power supply voltage Vdd in response to a light enable signal LE in a light enable phase. Here, the power supply voltage Vdd can be a variable power supply voltage, so that the power supply voltage Vdd is referred to as the variable power supply voltage Vdd hereinafter.

Moreover, the driving unit 107 is coupled between the power unit 105 and an anode of the OLED 101 (i.e. a first end of the light-emitting component), and includes a driving transistor T1 directly coupled to the anode of the OLED 101. The driving unit 107 controls a driving current I_{OLED} flowing through the OLED 101 in the light enable phase.

Moreover, the data storage unit 109 includes a storage capacitor Cst. The data storage unit 109 stores a data voltage Vdata and a threshold voltage Vₜₕ(T1) related to the driving transistor T1 through the storage capacitor Cst in a data-writing phase. Moreover, the data storage unit 109 initializes/resets the storage capacitor Cst in response to a reset scan signal S[n−1] in a reset phase. The reset scan signal S[n−1] can be a signal on a previous scan line, and is provided by a gate driving circuit of an (n−1)^{th} stage.

In the present exemplary embodiment, the driving unit 107 generates the driving current I_{OLED} flowing through the OLED 101 in response to a cross voltage of the storage capacitor Cst in the light enable phase, and the driving current I_{OLED} is not influenced by the power supply voltage Vdd and the threshold voltage Vₜₕ(T1) of the driving transistor T1. In other words, the driving current I_{OLED} is non-related to the power supply voltage Vdd and the threshold voltage Vₜₕ(T1) of the driving transistor T1.

Besides, the power unit 105 includes a power conduction transistor T2. Moreover, the data storage unit 109 further includes a writing transistor T3, a collection transistor T4 and a reset transistor T5.

In the present exemplary embodiment, the driving transistor T1, the power conduction transistor T2, the writing transistor T3, the collection transistor T4 and the reset transistor T5 are all P-type transistors, for example, P-type thin film transistors (P-type TFTs). Moreover, an OLED display panel applying the OLED pixel circuit 10 can be fabricated by a TFT process technique of low temperature polysilicon (LTPS), a-Si or a-IGZO, though the invention is not limited thereto.

Moreover, in a circuit configuration of the OLED pixel circuit 10 of FIG. 2, a source of the power conduction transmitter T2 receives the variable power supply voltage Vdd, and a gate of the power conduction transmitter T2 receives the light enable signal LE. A first drain/source of the driving transistor T1 is coupled to a drain of the power conduction transmitter T2, a second drain/source of the driving transistor T1 is coupled to an anode of the OLED 101, and a gate of the driving transistor T1 is coupled to a first end of the storage capacitor Cst. Moreover, a second end of the storage capacitor Cst is coupled to the variable power voltage Vdd.

A gate of the writing transistor T3 receives a writing scan signal S[n] (the writing scan signal S[n] can be a current scan line signal, and is provided by a gate driving circuit of an n^{th} stage), a drain of the writing transistor T3 receives the data voltage Vdata, and a source of the writing transistor T3 is coupled to the second drain/source of the driving transistor T1 and the anode of the OLED 101. A gate of the collection transistor T4 receives the writing scan signal S[n], a source of the collection transistor T4 is coupled to the gate of the driving transistor T1 and the first end of the storage capacitor Cst, and a drain of the collection transistor T4 is coupled to the first drain/source of the driving transistor T1 and the drain of the power conduction transistor T2. A gate of the reset transistor T5 is coupled to a source thereof to receive the reset scan signal S[n−1], and a drain of the reset transistor T5 is coupled to the gate of the driving transistor T1, the source of the collection transistor T4 and the first end of the storage capacitor Cst.

In this case, a cathode (i.e. a second end of the light-emitting component) of the OLED 101 is coupled to a reference voltage Vss, where a level of the reference voltage Vss is substantially not less than a highest level of the data voltage Vdata minus a conduction voltage (Voled_th) of the OLED 101, i.e. Vss≧Vdata−Voled_th.

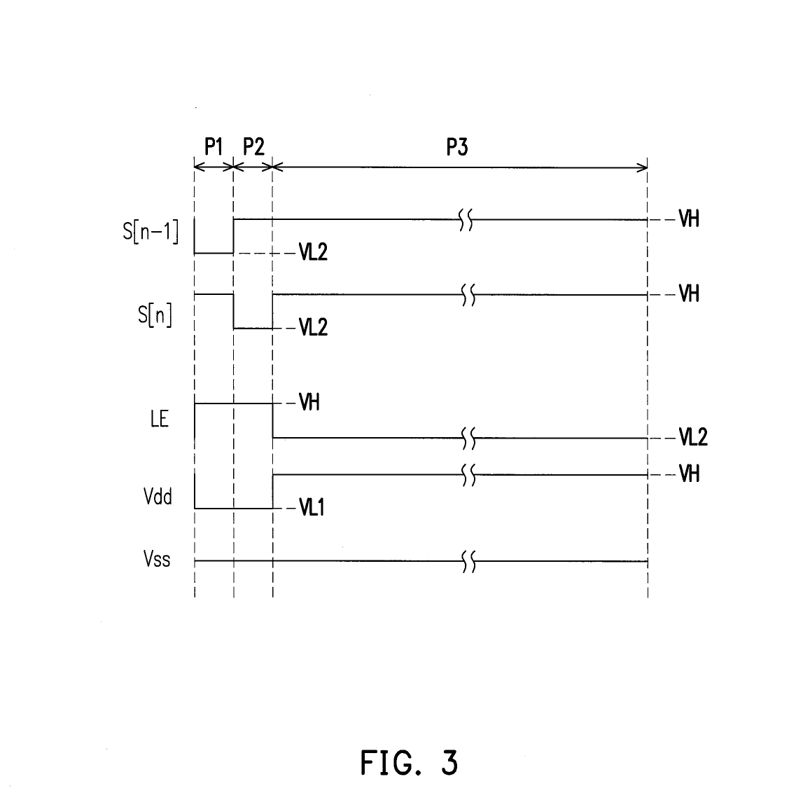

Moreover, during an operation process of the OLED pixel circuit 10 of FIG. 2, the light-emitting component driving circuit 103 (i.e. the OLED driving circuit) sequentially enters the reset phase, the data-writing phase and the light enable phase, which are respectively represented by P1, P2 and P3 of FIG. 3. In the present exemplary embodiment, the variable power supply voltage Vdd has a first low voltage level VL1 (for example, +4V, though the invention is not limited thereto) in the reset phase P1 and the data-writing phase P2, and has a high voltage level VH (for example, +14V, though the invention is not limited thereto) in the light enable phase P3.

Moreover, the light enable signal LE has the high voltage level VH in the reset phase P1 and the data-writing phase P2, and has a second low voltage level VL2 (for example, −6V, though the invention is not limited thereto) different to the first low voltage level LV1 in the light enable phase P3. Furthermore, the reset scan signal S[n−1] has the second low voltage level VL2 in the reset phase P1, and has the high voltage level VH in the data-writing phase P2 and the light enable phase P3. Besides, the writing scan signal S[n] has the second low voltage level VL2 in the data-writing phase P2, and has the high voltage level VH in the reset phase P1 and the light enable phase P3.

In other words, it is obvious in FIG. 3 that in the reset phase P1, only the reset scan signal S[n−1] is enabled; in the data-writing phase P2, only the writing scan signal S[n] is enabled; in the light enable phase P3, only the light enable signal LE is enabled; and the variable power supply voltage Vdd can be activated (i.e. in the high voltage level VH) only in the light enable phase P3. It should be noticed that since the driving transistor T1, the power conduction transistor T2, the writing transistor T3, the collection transistor T4 and the reset transistor T5 of the OLED pixel circuit 10 shown in FIG. 2 are all P-type transistors, it is known that the driving transistor T1, the power conduction transistor T2, the writing transistor T3, the collection transistor T4 and the reset transistor T5 are low level activation. Therefore, the aforementioned descriptions that the reset scan signal S[n−1], the writing scan signal S[n] and the light enable signal LE are enabled represent that the reset scan signal S[n−1], the writing scan signal S[n] and the light enable signal LE are in the low voltage level (i.e. VL2).

Therefore, in the reset phase P1, since only the reset scan signal S[n−1] is enabled, a voltage at the gate of the driving transistor T1 is equal to VL2+Vₜₕ(T5) in response to a turn-on state of the reset transistor T5, where Vₜₕ(T5) is a threshold voltage of the reset transistor T5. Meanwhile, the power conduction transistor T2 is in a turn-off state in response to disabling of the light enable signal LE, which avails avoiding a miss operation of sudden light up of the OLED 101 and maintaining a contrast of a display image. Moreover, the writing transistor T3 and the collection transistor T4 are also in the turn-off state in response to disabling of the writing scan signal S[n].

Then, in the data-writing phase P2, since only the writing scan signal S[n] is enabled, the writing transistor T3 and the collection transistor T4 are both in the turn-on state. In this case, the data voltage Vdata is transmitted to the storage capacitor Cst through the writing transistor T3 and the diode-connected driving transistor T1, so that the voltage at the gate of the driving transistor T1 is equal to Vdata−Vₜₕ(T1). In the data-writing phase P2, the second drain/source of the driving transistor T1 is substantially regarded as a source, and the first drain/source of the driving transistor T1 is substantially regarded as a drain.

Meanwhile, the reset transistor T5 and the power conduction transistor T2 are both in the turn-off state in response to disabling of the reset scan signal S[n−1] and the light enable signal LE. In addition, since the level of the reference voltage Vss is substantially not less than the highest level of the data voltage Vdata minus the conduction voltage (Voled_th) of the OLED 101, i.e. Vss≧Vdata−Voled_th, the OLED 101 is avoided to have the miss operation of sudden light up in the data-writing phase P2.

It should be noticed that the level of the reference voltage Vss of FIG. 3 is preferably controlled to be not less than the first low voltage level VL1 (for example, +4V) of the variable power supply voltage Vdd in the reset phase P1 and the data-writing phase P2, though the invention is not limited thereto. In this way, the OLED 101 is further guaranteed to avoid the miss operation of sudden light up in the reset phase P1 and the data-writing phase P2.

Finally, in the light enable phase P3, since only the light enable signal LE is enabled, the writing transistor T3, the collection transistor T4 and the reset transistor T5 are all in the turn-off state, and the driving transistor T1 and the power conduction transistor T2 are in the turn-on state. Meanwhile, since the second drain/source of the driving transistor T1 is changed to the drain, and the first drain/source of the driving transistor T1 is changed to the source, such that in response to the turn-on state of the power conduction transistor T2, the voltage of the source of the driving transistor T1 is substantially equal to VH, and the voltage of the gate of the driving transistor T1 is increased to Vdata−Vₜₕ(T1)+(VH−VL1) in response to a capacitor coupling effect of the storage capacitor Cst. In this way, the driving transistor T1 generates the driving current I_{OLED} that is not influenced by the power supply voltage Vdd and the threshold voltage Vₜₕ(T1) of the driving transistor T1 to flow through the OLED 101.

In detail, in the light enable phase P3, the driving current I_{OLED} generated by the driving transistor T1 can be represented by a following equation 1:

$${I}_{OLED} = \frac{1}{2} K \times {( Vsg - {V}_{th} ( T 1 ) )}^{2} \qquad 1$$

Where, K is a current constant related to the driving transistor T1.

Moreover, since a source gate voltage (Vsg) of the driving transistor T1 is already known, i.e.: Vsg=VH−[Vdata−Vₜₕ(T1)+(VH−VL1)].

Therefore, substituting the known source gate voltage (Vsg) of the driving transistor T1 into the equation 1, the equation 1 can be rewritten as:

$${I}_{OLED} = \frac{1}{2} K \times [ VH - {( Vdata - {V}_{th} ( T 1 ) + ( VH = VL 1 ) - {V}_{th} ( T 1 ) ]}^{2} , \qquad 2$$

and the equation 2 can be further simplified as a following equation 3:

$${I}_{OLED} = \frac{1}{2} K \times {( VL 1 - Vdata )}^{2} \qquad 3$$

Therefore, the driving transistor T1 can generate the driving current I_{OLED} that is not influenced by the power supply voltage Vdd and the threshold voltage Vₜₕ(T1) of the driving transistor T1 in the light enable phase P3.

In other words, according to the equation 3, it is known that the driving current I_{OLED} flowing through the OLED 101 is non-related to the power supply voltage Vdd and the threshold voltage Vₜₕ(T1) of the driving transistor T1, and is related to the data voltage Vdata. In this way, a threshold voltage variation of the TFT caused by process factors can be compensated, and meanwhile the problem that the power supply voltage Vdd is changed due to influence of the IR drop is resolved.

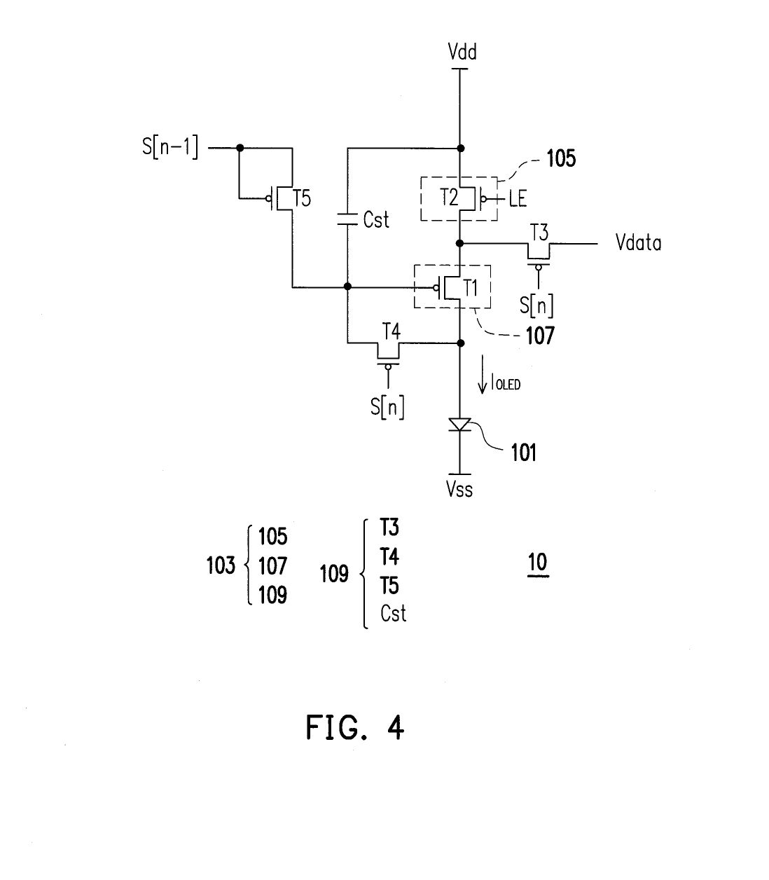

On the other hand, FIG. 4 is another circuit diagram of the OLED pixel circuit 10 of FIG. 1. Referring to FIG. 1 and FIG. 4, in the present exemplary embodiment, regarding a circuit configuration of the OLED pixel circuit 10 of FIG. 4, the source of the power conduction transistor T2 receives the variable power supply voltage Vdd, and the gate of the power conduction transistor T2 receives the light enable signal LE. The first drain/source of the driving transistor T1 is coupled to the drain of the power conduction transistor T2, the second drain/source of the driving transistor T1 is coupled to the anode of the OLED 101, and the gate of the driving transistor T1 is coupled to the first end of the storage capacitor Cst. Moreover, the second end of the storage capacitor Cst is coupled to the variable power supply voltage Vdd.

The gate of the writing transistor T3 receives the writing scan signal S[n], the drain of the writing transistor T3 receives the data voltage Vdata, and the source of the writing transistor T3 is coupled to the first drain/source of the driving transistor T1 and the drain of the power conduction transistor T2. The gate of the collection transistor T4 receives the writing scan signal S[n], the source of the collection transistor T4 is coupled to the gate of the driving transistor T1 and the first end of the storage capacitor Cst, and the drain of the collection transistor T4 is coupled to the second drain/source of the driving transistor T1 and the anode of the OLED 101. The gate and the source of the reset transistor T5 are coupled with each other to receive the reset scan signal S[n−1], and the drain of the reset transistor T5 is coupled to the gate of the driving transistor T1, the source of the collection transistor T4 and the first end of the storage capacitor Cst.

In this case, the cathode of the OLED 101 is coupled to the reference voltage Vss, and the level of the reference voltage Vss is substantially not less than the highest level of the data voltage Vdata minus the threshold voltage Vₜₕ(T1) of the driving transistor T1 and the conduction voltage Voled_th of the OLED 101, i.e. Vss≧Vdata−Vₜₕ(T1)−Voled_th.

It should be noticed that the operation waveforms of FIG. 3 are also adapted to the circuit configuration of FIG. 4, therefore, in the reset phase P1, since only the reset scan signal S[n−1] is enabled, the voltage at the gate of the driving transistor T1 is equal to VL2+Vₜₕ(T5) in response to the turn-on state of the reset transistor T5. Meanwhile, the power conduction transistor T2 is in the turn-off state in response to disabling of the light enable signal LE, which avails avoiding a miss operation of sudden light up of the OLED 101 and maintaining a contrast of a display image. Moreover, the writing transistor T3 and the collection transistor T4 are also in the turn-off state in response to disabling of the writing scan signal S[n].

Then, in the data-writing phase P2, since only the writing scan signal S[n] is enabled, the writing transistor T3 and the collection transistor T4 are both in the turn-on state. In this case, the data voltage Vdata is transmitted to the storage capacitor Cst through the writing transistor T3 and the diode-connected driving transistor T1, so that the voltage at the gate of the driving transistor T1 is equal to Vdata−Vₜₕ(T1). In the data-writing phase P2, the second drain/source of the driving transistor T1 is substantially regarded as a source, and the first drain/source of the driving transistor T1 is substantially regarded as a drain.

Meanwhile, the reset transistor T5 and the power conduction transistor T2 are both in the turn-off state in response to disabling of the reset scan signal S[n−1] and the light enable signal LE. In addition, since the level of the reference voltage Vss is substantially not less than the highest level of the data voltage Vdata minus the threshold voltage Vₜₕ(T1) of the driving transistor T1 and the conduction voltage (Voled_th) of the OLED 101, i.e. Vss≧Vdata−Vₜₕ(T1)−Voled_th, the OLED 101 is avoided to have the miss operation of sudden light up in the data-writing phase P2.

Finally, in the light enable phase P3, since only the light enable signal LE is enabled, the writing transistor T3, the collection transistor T4 and the reset transistor T5 are all in the turn-off state, and the driving transistor T1 and the power conduction transistor T2 are in the turn-on state. Meanwhile, since the second drain/source of the driving transistor T1 is changed to the drain, and the first drain/source of the driving transistor T1 is changed to the source, such that in response to the turn-on state of the power conduction transistor T2, the voltage of the source of the driving transistor T1 is substantially equal to VH, and the voltage of the gate of the driving transistor T1 is increased to Vdata−Vₜₕ(T1)+(VH−VL1) in response to the capacitor coupling effect of the storage capacitor Cst. In this way, the driving transistor T1 generates the driving current I_{OLED} (shown as the equations 1-3) that is not influenced by the power supply voltage Vdd and the threshold voltage Vₜₕ(T1) of the driving transistor T1 to flow through the OLED 101. Obviously, the circuit configuration of FIG. 4 may also achieve technique effects similar to that of the circuit configuration of FIG. 2.

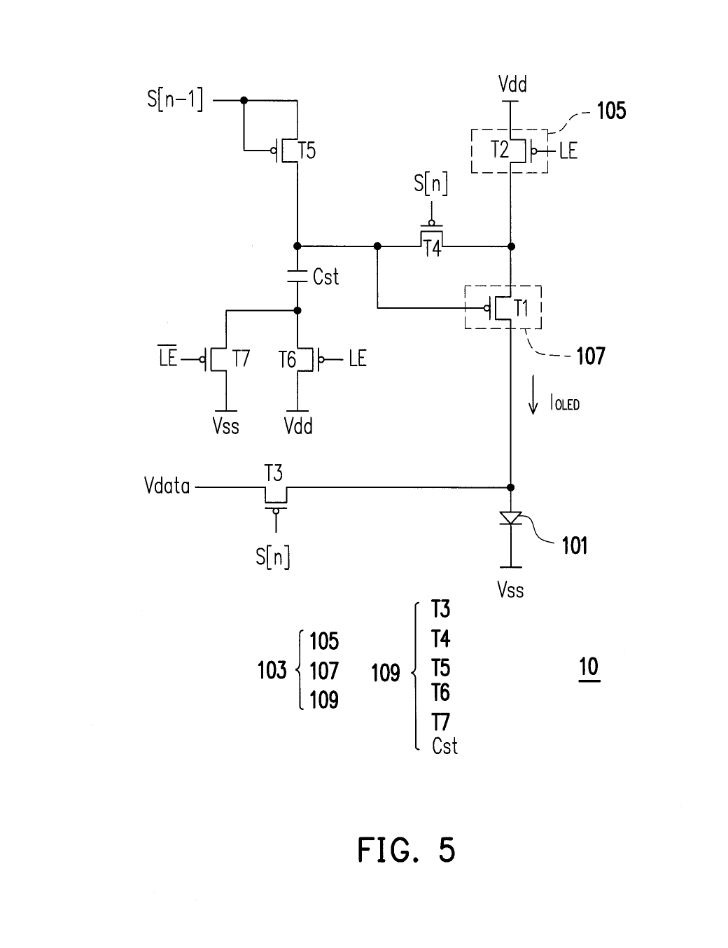

On the other hand, FIG. 5 is another circuit diagram of the OLED pixel circuit 10 of FIG. 1. Referring to FIG. 1 and FIG. 5, in the present exemplary embodiment, regarding a circuit configuration of the OLED pixel circuit 10 of FIG. 5, the source of the power conduction transistor T2 is changed to receive a constant power supply voltage Vdd having the high voltage level VH, and the gate of the power conduction transistor T2 receives the light enable signal LE. The first drain/source of the driving transistor T1 is coupled to the drain of the power conduction transistor T2, the second drain/source of the driving transistor T1 is coupled to the anode of the OLED 101, and the gate of the driving transistor T1 is coupled to the first end of the storage capacitor Cst.

Moreover, the second end of the storage capacitor Cst is respectively coupled to the constant power supply voltage Vdd and the reference voltage Vss through a first switching transistor T6 and a second switching transistor T7 (which are P-type transistors, for example, P-type TFTs, though the invention is not limited thereto). A gate of the first switching transistor T6 receives the light enable signal LE, a source of the first switching transistor T6 is coupled to the constant power supply voltage Vdd, and a drain of the first switching transistor T6 is coupled to the second end of the storage capacitor Cst. A gate of the second switching transistor T7 receives a complementary signal L̅E̅ of the light enable signal LE, a source of the second switching transistor T7 is coupled to the reference voltage Vss, and a drain of the second switching transistor T7 is coupled to the second end of the storage capacitor Cst.

Similarly, the gate of the writing transistor T3 receives the writing scan signal S[n], the drain of the writing transistor T3 receives the data voltage Vdata, and the source of the writing transistor T3 is coupled to the second drain/source of the driving transistor T1 and the anode of the OLED 101. The gate of the collection transistor T4 receives the writing scan signal S[n], the source of the collection transistor T4 is coupled to the gate of the driving transistor T1 and the first end of the storage capacitor Cst, and the drain of the collection transistor T4 is coupled to the first drain/source of the driving transistor T1 and the drain of the power conduction transistor T2. The gate and the source of the reset transistor T5 are coupled with each other to receive the reset scan signal S[n−1], and the drain of the reset transistor T5 is coupled to the gate of the driving transistor T1, the source of the collection transistor T4 and the first end of the storage capacitor Cst.

In this case, the cathode of the OLED 101 is coupled to the reference voltage Vss, and the level of the reference voltage Vss is substantially not less than the highest level of the data voltage Vdata minus the conduction voltage Voled_th of the OLED 101, i.e. Vss≧Vdata−Voled_th.

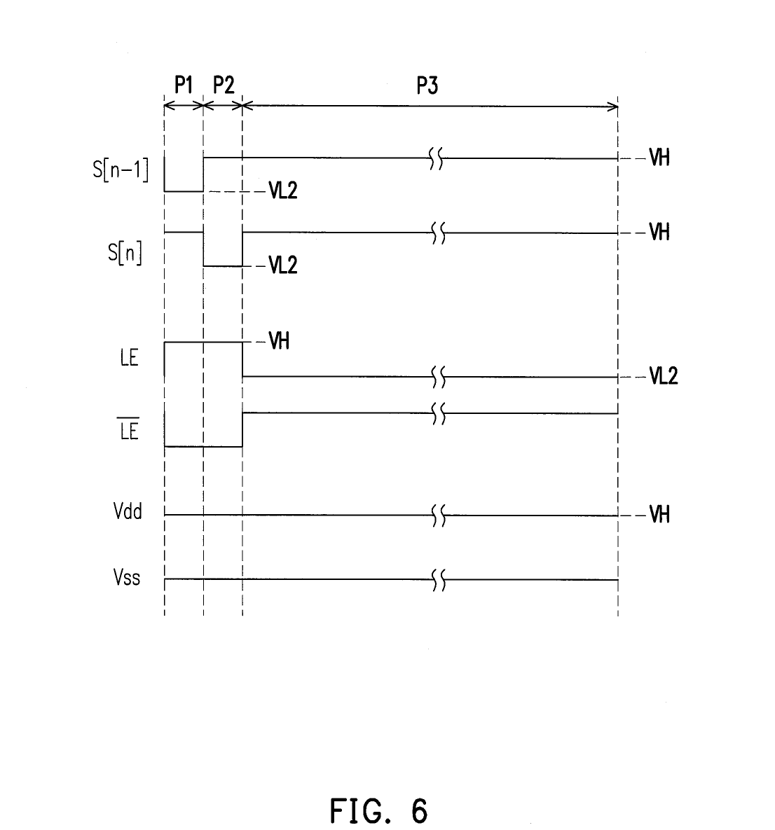

Moreover, in the operation process of the OLED pixel circuit 10 of FIG. 5, the light-emitting component driving circuit 103 (i.e. the OLED driving circuit) also sequentially enters the reset phase, the data-writing phase and the light enable phase, which are respectively represented by P1, P2 and P3 of FIG. 6. Therefore, in the reset phase P1, since the reset scan signal S[n−1] and the complementary signal L̅E̅ of the light enable signal LE can be simultaneously enabled, the voltage at the gate of the driving transistor T1 is equal to VL2+Vₜₕ(T5) in response to the turn-on state of the reset transistor T5. Moreover, the second switching transistor T7 is turned on in response to enabling of the complementary signal L̅E̅ of the light enable signal LE.

Meanwhile, the power conduction transistor T2 is in the turn-off state in response to disabling of the light enable signal LE, which avails avoiding the miss operation of sudden light up of the OLED 101 and maintains a contrast of a display image. Moreover, the first switching transistor T6 is in the turn-off state in response to disabling of the light enable signal LE. In addition, the writing transistor T3 and the collection transistor T4 are also in the turn-off state in response to disabling of the writing scan signal S[n].

Then, in the data-writing phase P2, since the writing scan signal S[n] and the complementary signal L̅E̅ of the light enable signal LE can be simultaneously enabled, the writing transistor T3, the collection transistor T4 and the second switching transistor T7 are simultaneously in the turn-on state. In this case, the data voltage Vdata is transmitted to the storage capacitor Cst through the writing transistor T3 and the diode-connected driving transistor T1, so that the voltage at the gate of the driving transistor T1 is equal to Vdata−Vₜₕ(T1). Similarly, in the data-writing phase P2, the second drain/source of the driving transistor T1 is substantially regarded as the source, and the first drain/source of the driving transistor T1 is substantially regarded as the drain.

Meanwhile, the reset transistor T5 and the power conduction transistor T2 are both in the turn-off state in response to disabling of the reset scan signal S[n−1] and the light enable signal LE. In addition, since the level of the reference voltage Vss is substantially not less than the highest level of the data voltage Vdata minus the conduction voltage (Voled_th) of the OLED 101, i.e. Vss≧Vdata−Voled_th, the OLED 101 is avoided to have the miss operation of sudden light up in the data-writing phase P2.

Finally, in the light enable phase P3, since only the light enable signal LE is enabled, the writing transistor T3, the collection transistor T4, the reset transistor T5 and the second switching transistor T7 are all in the turn-off state, and the driving transistor T1 and the power conduction transistor T2 and the first switching transistor T6 are in the turn-on state. Meanwhile, since the second drain/source of the driving transistor T1 is changed to the drain, and the first drain/source of the driving transistor T1 is changed to the source, such that in response to the turn-on state of the power conduction transistor T2, the voltage of the source of the driving transistor T1 is substantially equal to VH, and the voltage of the gate of the driving transistor T1 is increased to Vdata−Vₜₕ(T1)+(VH−VL1) in response to the capacitor coupling effect of the storage capacitor Cst. In this way, the driving transistor T1 generates the driving current I_{OLED} (shown as the equations 1-3) that is not influenced by the power supply voltage Vdd and the threshold voltage Vₜₕ(T1) of the driving transistor T1 to flow through the OLED 101. Obviously, the circuit configuration of FIG. 5 may also achieve technique effects similar to that of the circuit configuration of FIG. 2.

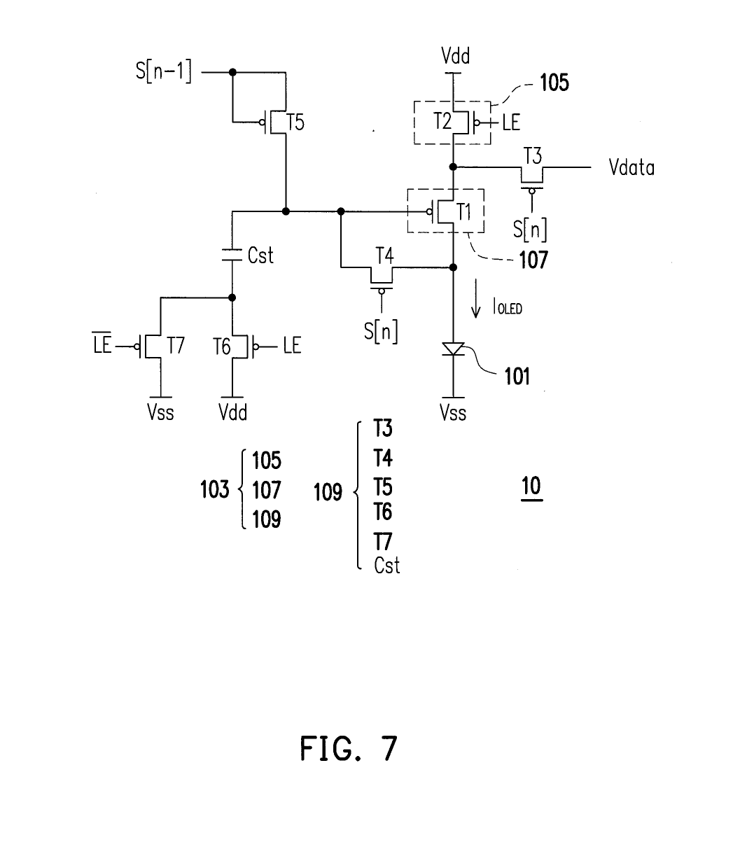

On the other hand, FIG. 7 is another circuit diagram of the OLED pixel circuit 10 of FIG. 1. Referring to FIG. 1 and FIG. 7, in the present exemplary embodiment, regarding a circuit configuration of the OLED pixel circuit 10 of FIG. 7, the source of the power conduction transistor T2 also receives the constant power supply voltage Vdd having the high voltage level VH, and the gate of the power conduction transistor T2 receives the light enable signal LE. The first drain/source of the driving transistor T1 is coupled to the drain of the power conduction transistor T2, the second drain/source of the driving transistor T1 is coupled to the anode of the OLED 101, and the gate of the driving transistor T1 is coupled to the first end of the storage capacitor Cst.

Similarly, the second end of the storage capacitor Cst is respectively coupled to the constant power supply voltage Vdd and the reference voltage Vss through the first switching transistor T6 and the second switching transistor T7. A gate of the first switching transistor T6 receives the light enable signal LE, a source of the first switching transistor T6 is coupled to the constant power supply voltage Vdd, and a drain of the first switching transistor T6 is coupled to the second end of the storage capacitor Cst. A gate of the second switching transistor T7 receives a complementary signal L̅E̅ of the light enable signal LE, a source of the second switching transistor T7 is coupled to the reference voltage Vss, and a drain of the second switching transistor T7 is coupled to the second end of the storage capacitor Cst.

The gate of the writing transistor T3 receives the writing scan signal S[n], the drain of the writing transistor T3 receives the data voltage Vdata, and the source of the writing transistor T3 is coupled to the first drain/source of the driving transistor T1 and the drain of the power conduction transistor T2. The gate of the collection transistor T4 receives the writing scan signal S[n], the source of the collection transistor T4 is coupled to the gate of the driving transistor T1 and the first end of the storage capacitor Cst, and the drain of the collection transistor T4 is coupled to the second drain/source of the driving transistor T1 and the anode of the OLED 101. The gate and the source of the reset transistor T5 are coupled with each other to receive the reset scan signal S[n−1], and the drain of the reset transistor T5 is coupled to the gate of the driving transistor T1, the source of the collection transistor T4 and the first end of the storage capacitor Cst.

In this case, the cathode of the OLED 101 is coupled to the reference voltage Vss, and the level of the reference voltage Vss is substantially not less than the highest level of the data voltage Vdata minus the threshold voltage Vₜₕ(T1) of the driving transistor T1 and the conduction voltage Voled_th of the OLED 101, i.e. Vss≧Vdata−Vₜₕ(T1)−Voled_th.

It should be noticed that the operation waveforms of FIG. 6 are also adapted to the circuit configuration of FIG. 7, therefore, in the reset phase P1, since the reset scan signal S[n−1] and the complementary signal L̅E̅ of the light enable signal LE can be simultaneously enabled, the voltage at the gate of the driving transistor T1 is equal to VL2+Vₜₕ(T5) in response to the turn-on state of the reset transistor T5. Moreover, the second switching transistor T7 is turned on in response to enabling of the complementary signal L̅E̅ of the light enable signal LE.

Meanwhile, the power conduction transistor T2 is in the turn-off state in response to disabling of the light enable signal LE, which avails avoiding the miss operation of sudden light up of the OLED 101 and maintains a contrast of a display image. Moreover, the first switching transistor T6 is in the turn-off state in response to disabling of the light enable signal LE. In addition, the writing transistor T3 and the collection transistor T4 are also in the turn-off state in response to disabling of the writing scan signal S[n].

Then, in the data-writing phase P2, since the writing scan signal S[n] and the complementary signal L̅E̅ of the light enable signal LE can be simultaneously enabled, the writing transistor T3, the collection transistor T4 and the second switching transistor T7 are simultaneously in the turn-on state. In this case, the data voltage Vdata is transmitted to the storage capacitor Cst through the writing transistor T3 and the diode-connected driving transistor T1, so that the voltage at the gate of the driving transistor T1 is equal to Vdata−Vₜₕ(T1). Similarly, in the data-writing phase P2, the second drain/source of the driving transistor T1 is substantially regarded as the source, and the first drain/source of the driving transistor T1 is substantially regarded as the drain.

Meanwhile, the reset transistor T5 and the power conduction transistor T2 are both in the turn-off state in response to disabling of the reset scan signal S[n−1] and the light enable signal LE. In addition, since the level of the reference voltage Vss is substantially not less than the highest level of the data voltage Vdata minus the threshold voltage Vₜₕ(T1) of the driving transistor T1 and the conduction voltage (Voled_th) of the OLED 101, i.e. Vss≧Vdata−Vₜₕ(T1)−Voled_th, the OLED 101 is avoided to have the miss operation of sudden light up in the data-writing phase P2.

Finally, in the light enable phase P3, since only the light enable signal LE is enabled, the writing transistor T3, the collection transistor T4, the reset transistor T5 and the second switching transistor T7 are all in the turn-off state, and the driving transistor T1 and the power conduction transistor T2 and the first switching transistor T6 are in the turn-on state. Meanwhile, since the second drain/source of the driving transistor T1 is changed to the drain, and the first drain/source of the driving transistor T1 is changed to the source, such that in response to the turn-on state of the power conduction transistor T2, the voltage of the source of the driving transistor T1 is substantially equal to VH, and the voltage of the gate of the driving transistor T1 is increased to Vdata−Vₜₕ(T1)+(VH−VL1) in response to the capacitor coupling effect of the storage capacitor Cst. In this way, the driving transistor T1 generates the driving current I_{OLED} (shown as the equations 1-3) that is not influenced by the power supply voltage Vdd and the threshold voltage Vₜₕ(T1) of the driving transistor T1 to flow through the OLED 101. Obviously, the circuit configuration of FIG. 7 may also achieve technique effects similar to that of the circuit configuration of FIG. 2.

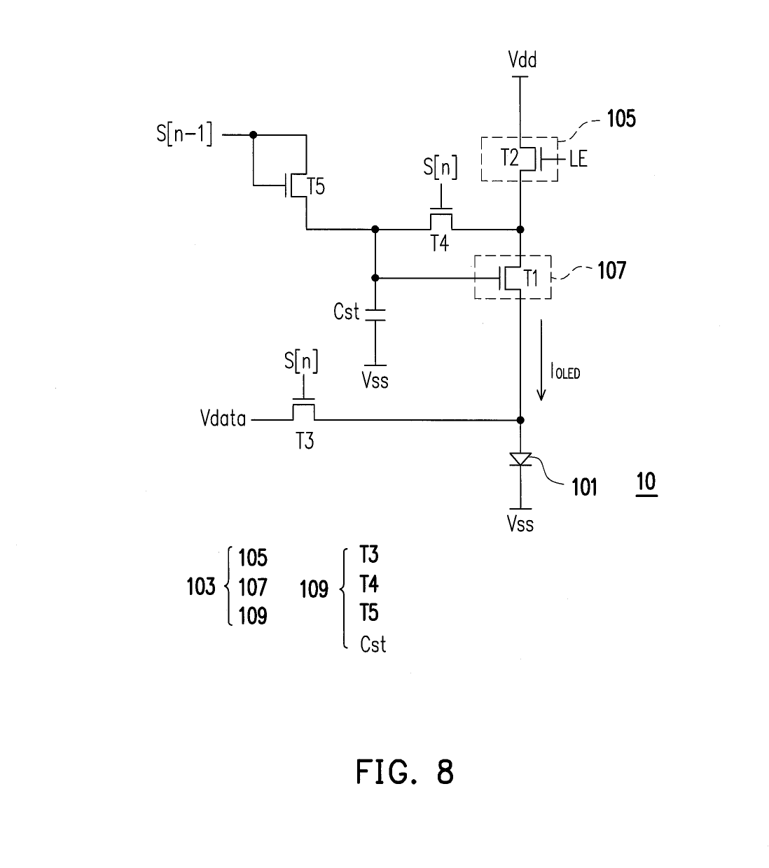

On the other hand, FIG. 8 is another circuit diagram of the OLED pixel circuit 10 of FIG. 1. Referring to FIG. 1 and FIG. 8, in the present exemplary embodiment, the driving transistor T1, the power conduction transistor T2, the writing transistor T3, the collection transistor T4 and the reset transistor T5 are all N-type transistors, for example, N-type TFTs. Moreover, an OLED display panel applying the OLED pixel circuit 10 can be fabricated according to a TFT process technique of low temperature polysilicon (LTPS), a-Si or a-IGZO, though the invention is not limited thereto.

Moreover, regarding a circuit configuration of the OLED pixel circuit 10 of FIG. 8, the drain of the power conduction transistor T2 also receives the constant power supply voltage Vdd having the high voltage level VH, and the gate of the power conduction transistor T2 receives the light enable signal LE. The drain of the driving transistor T1 is coupled to the source of the power conduction transistor T2, the source of the driving transistor T1 is coupled to the anode of the OLED 101, and the gate of the driving transistor T1 is coupled to the first end of the storage capacitor Cst. Moreover, the second end of the storage capacitor Cst is coupled to the reference voltage Vss.

The gate of the writing transistor T3 receives the writing scan signal S[n], the drain of the writing transistor T3 receives the data voltage Vdata, and the source of the writing transistor T3 is coupled to the source of the driving transistor T1 and the anode of the OLED 101. The gate of the collection transistor T4 receives the writing scan signal S[n], the source of the collection transistor T4 is coupled to the gate of the driving transistor T1 and the first end of the storage capacitor Cst, and the drain of the collection transistor T4 is coupled to the drain of the driving transistor T1 and the source of the power conduction transistor T2. The gate and the source of the reset transistor T5 are coupled with each other to receive the reset scan signal S[n−1], and the drain of the reset transistor T5 is coupled to the gate of the driving transistor T1, the source of the collection transistor T4 and the first end of the storage capacitor Cst.

In this case, the cathode of the OLED 101 is coupled to the reference voltage Vss, and the level of the reference voltage Vss is substantially not less than the highest level of the data voltage Vdata minus the conduction voltage Voled_th of the OLED 101, i.e. Vss≧Vdata−Voled_th.

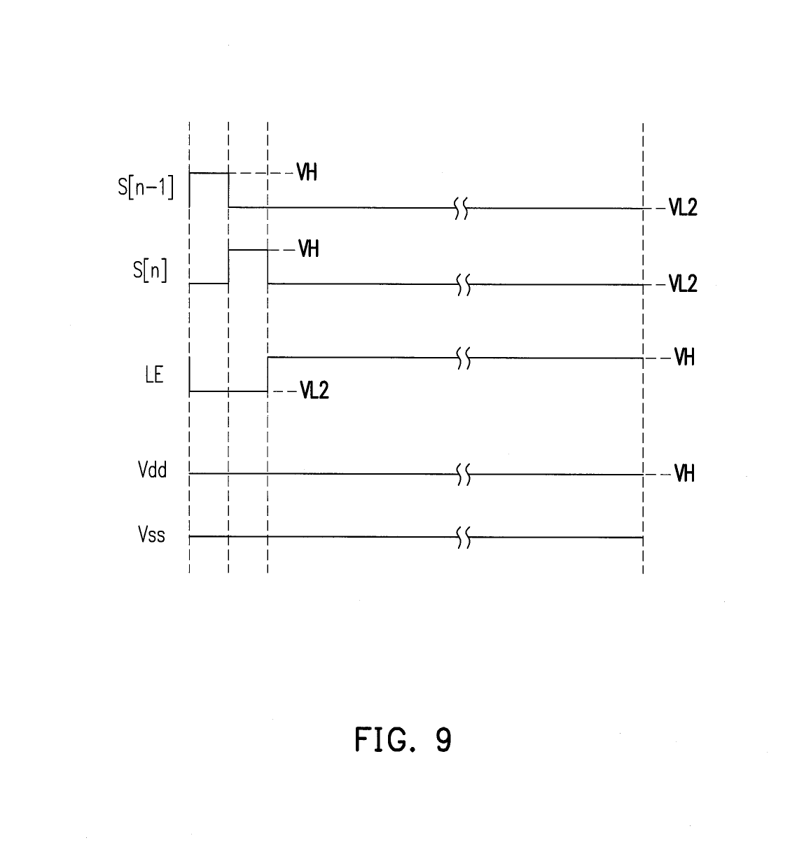

Moreover, during an operation process of the OLED pixel circuit 10 of FIG. 8, the light-emitting component driving circuit 103 (i.e. the OLED driving circuit) sequentially enters the reset phase, the data-writing phase and the light enable phase, which are respectively represented by P1, P2 and P3 of FIG. 9. In the present exemplary embodiment, the constant power supply voltage Vdd has the high voltage level VH. Moreover, the light enable signal LE has the second low voltage level VL2 different to the reference voltage Vss in the reset phase P1 and the data-writing phase P2, and has the high voltage level VH in the light enable phase P3. Furthermore, the reset scan signal S[n−1] has the high voltage level VH in the reset phase P1, and has the second low voltage level VL2 in the data-writing phase P2 and the light enable phase P3. Besides, the writing scan signal S[n] has the high voltage level VH in the data-writing phase P2, and has the second low voltage level VL2 in the reset phase P1 and the light enable phase P3.

Similarly, it is obvious in FIG. 9 that in the reset phase P1, only the reset scan signal S[n−1] is enabled; in the data-writing phase P2, only the writing scan signal S[n] is enabled; in the light enable phase P3, only the light enable signal LE is enabled. It should be noticed that since the driving transistor T1, the power conduction transistor T2, the writing transistor T3, the collection transistor T4 and the reset transistor T5 of the OLED pixel circuit 10 are all N-type transistors, it is known that the driving transistor T1, the power conduction transistor T2, the writing transistor T3, the collection transistor T4 and the reset transistor T5 are high level activation. Therefore, the aforementioned descriptions that the reset scan signal S[n−1], the writing scan signal S[n] and the light enable signal LE are enabled represent that the reset scan signal S[n−1], the writing scan signal S[n] and the light enable signal LE are in the high voltage level (i.e. VH).

Therefore, in the reset phase P1, since only the reset scan signal S[n−1] is enabled, the voltage at the gate of the driving transistor T1 is equal to VH−Vₜₕ(T5) in response to a turn-on state of the reset transistor T5. Meanwhile, the power conduction transistor T2 is in a turn-off state in response to disabling of the light enable signal LE, which avails avoiding a miss operation of sudden light up of the OLED 101 and maintaining a contrast of a display image. Moreover, the writing transistor T3 and the collection transistor T4 are also in the turn-off state in response to disabling of the writing scan signal S[n].

Then, in the data-writing phase P2, since only the writing scan signal S[n] is enabled, the writing transistor T3 and the collection transistor T4 are both in the turn-on state. In this case, the data voltage Vdata is transmitted to the storage capacitor Cst through the writing transistor T3 and the diode-connected driving transistor T1, so that the voltage at the gate of the driving transistor T1 is equal to Vdata+Vₜₕ(T1).

Meanwhile, the reset transistor T5 and the power conduction transistor T2 are both in the turn-off state in response to disabling of the reset scan signal S[n−1] and the light enable signal LE. In addition, since the level of the reference voltage Vss is substantially not less than the highest level of the data voltage Vdata minus the conduction voltage (Voled_th) of the OLED 101, i.e. Vss Vdata−Voled_th, the OLED 101 is avoided to have the miss operation of sudden light up in the data-writing phase P2.

Finally, in the light enable phase P3, since only the light enable signal LE is enabled, the writing transistor T3, the collection transistor T4 and the reset transistor T5 are all in the turn-off state, and the driving transistor T1 and the power conduction transistor T2 are in the turn-on state. Meanwhile, the driving current I_{OLED} that is not influenced by the power supply voltage Vdd and the threshold voltage Vₜₕ(T1) of the driving transistor T1 is generated in response to the high voltage level VH of the constant power supply voltage Vdd to flow through the OLED 101. Since the voltage of the gate of the driving transistor T1 is Vdata+Vₜₕ(T1), and the voltage of the source of the driving voltage T1 is substantially the conduction voltage Voled_th of the OLED 101, in the light enable phase P3, the driving current I_{OLED} generated by the driving transistor T1 can be represented by a following equation 4:

$${I}_{OLED} = \frac{1}{2} K \times {( Vgs - {V}_{th} ( T 1 ) )}^{2} \qquad 4$$

Where, K is a current constant related to the driving transistor T1.

Moreover, since a gate source voltage (Vgs) of the driving transistor T1 is already known, i.e.: Vgs=Vdata+Vₜₕ(T1)−Voled_th.

Therefore, substituting the known gate source voltage (Vgs) of the driving transistor T1 into the equation 4, the equation 4 can be rewritten as:

$${{I}_{OLED} = \frac{1}{2} K \times [ Vdata + {V}_{th} ( T 1 ) - Voled\_th ) - {V}_{th} ( T 1 ) ]}^{2} \qquad 5$$

and the equation 5 can be further simplified as a following equation 6:

$${I}_{OLED} = \frac{1}{2} K \times {( Vdata - Voled\_th )}^{2} \qquad 6$$

Therefore, the driving transistor T1 can generate the driving current I_{OLED} that is not influenced by the power supply voltage Vdd and the threshold voltage Vₜₕ(T1) of the driving transistor T1 in the light enable phase P3.

In other words, according to the equation 6, it is known that the driving current I_{OLED} flowing through the OLED 101 is non-related to the power supply voltage Vdd and the threshold voltage Vₜₕ(T1) of the driving transistor T1, and is substantially only related to the data voltage Vdata. In this way, a threshold voltage variation of the TFT caused by process factors can be compensated, and meanwhile the problem that the power supply voltage Vdd is changed due to influence of the IR drop is resolved.

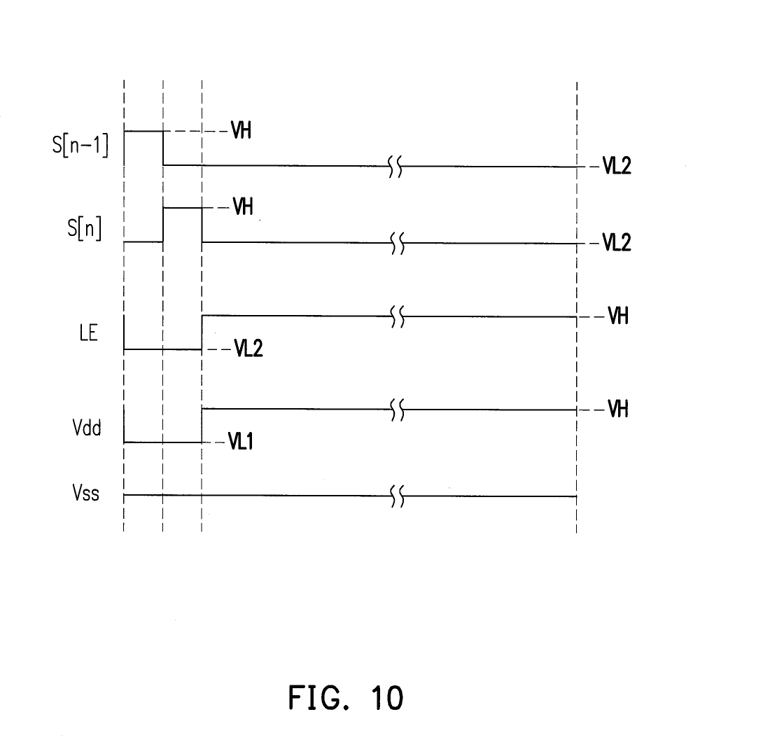

On the other hand, the drain of the power conduction transistor T2 of FIG. 8 can be changed to receive the variable power supply voltage Vdd, as that shown in FIG. 10. In this way, the variable power supply voltage Vdd has the first low voltage level VL1 in the reset phase P1 and the data-writing phase P2, and has the high voltage level VH in the light enable phase P3. Similarly, the voltage level of the reference voltage Vss of FIG. 10 is preferably controlled to be not less than the first low voltage level VL1 (for example, +4V) of the variable power supply voltage Vdd in the reset phase P1 and the data-writing phase P2, though the invention is not limited thereto. In this way, the OLED 101 is further guaranteed to avoid the miss operation of sudden light up in the reset phase P1 and the data-writing phase P2. Moreover, since the operation method of FIG. 10 implemented by the circuit configuration of FIG. 8 is similar to that of FIG. 9, details thereof are not repeated.

Therefore, the circuit configuration of the OLED pixel circuit 10 disclosed by the aforementioned exemplary embodiment is 5T1C (i.e. 5 TFTs+1 capacitor), and in collaboration with suitable operation waveforms (shown in FIG. 3, FIG. 6 and FIG. 9), the current I_{OLED} flowing through the OLED 101 is not changed along with the power supply voltage Vdd which may be influenced by the IR drop, and is not varied along with the threshold voltage (Vth) shift of the driving transistor T1 used for driving the OLED 101. Accordingly, the brightness uniformity of the applied OLED display can be substantially improved. Besides, any OLED display panel or OLED display using the OLED pixel circuit 10 of the aforementioned exemplary embodiment is considered to be within a protection range of the invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light-emitting component driving circuit, comprising:
a power unit, receiving a power supply voltage, and transmitting the power supply voltage in response to a light enable signal in a light enable phase;
a driving unit, coupled between the power unit and a light-emitting component, comprising a driving transistor coupled to a first end of the light-emitting component, and controlling a driving current flowing through the light-emitting component in the light enable phase; and
a data storage unit, comprising a storage capacitor, and storing a data voltage and a threshold voltage related to the driving transistor through the storage capacitor in a data-writing phase,
wherein in the light enable phase, the driving unit generates the driving current flowing through the light-emitting component in response to a cross voltage of the storage capacitor, and the driving current is not influenced by the power supply voltage and the threshold voltage of the driving transistor.

2. The light-emitting component driving circuit as claimed in claim 1, wherein a second end of the light-emitting component is coupled to a reference voltage, the power supply voltage is a variable power supply voltage, and the power unit comprises:
a power conduction transistor, having a source receiving the variable power supply voltage, and a gate receiving the light enable signal.

3. The light-emitting component driving circuit as claimed in claim 2, wherein
a first drain/source of the driving transistor is coupled to a drain of the power conduction transistor, a second drain/source of the driving transistor is coupled to the first end of the light-emitting component, and a gate of the driving transistor is coupled to a first end of the storage capacitor; and
a second end of the storage capacitor is coupled to the variable power supply voltage.

4. The light-emitting component driving circuit as claimed in claim 3, wherein the data storage unit further comprises:
a writing transistor, having a gate receiving a writing scan signal, a drain receiving the data voltage, and a source coupled to the second drain/source of the driving transistor and the first end of the light-emitting component; and
a collection transistor, having a gate receiving the writing scan signal, a source coupled to the gate of the driving transistor and the first end of the storage capacitor, and a drain coupled to the first drain/source of the driving transistor and the drain of the power conduction transistor,
wherein the light-emitting component is an organic light-emitting diode, and the first end of the light-emitting component is an anode of the organic light-emitting diode, and the second end of the light-emitting component is a cathode of the organic light-emitting diode,
wherein a level of the reference voltage is substantially not less than a highest level of the data voltage minus a conduction voltage of the organic light-emitting diode.

5. The light-emitting component driving circuit as claimed in claim 4, wherein the data storage unit further initializes the storage capacitor in response to a reset scan signal in a reset phase.

6. The light-emitting component driving circuit as claimed in claim 5, wherein the data storage unit further comprises:
a reset transistor, having a gate and a source coupled with each other to receive the reset scan signal, and a drain coupled to the gate of the driving transistor, the source of the collection transistor and the first end of the storage capacitor.

7. The light-emitting component driving circuit as claimed in claim 6, wherein the driving transistor, the power conduction transistor, the writing transistor, the collection transistor and the reset transistor are all P-type transistors.

8. The light-emitting component driving circuit as claimed in claim 7, wherein the light-emitting component driving circuit is an organic light-emitting diode driving circuit, and the organic light-emitting diode driving circuit sequentially enters the reset phase, the data-writing phase and the light enable phase.

9. The light-emitting component driving circuit as claimed in claim 8, wherein
in the reset phase and the data-writing phase, the variable power supply voltage has a first low voltage level; and
in the light enable phase, the variable power supply voltage has a high voltage level,
wherein the level of the reference voltage is further substantially not less than the first low voltage level of the variable power supply voltage in the reset phase and the data-writing phase.

10. The light-emitting component driving circuit as claimed in claim 9, wherein
in the reset phase and the data-writing phase, the light enable signal has the high voltage level; and
in the light enable phase, the light enable signal has a second low voltage level different to the first low voltage level.

11. The light-emitting component driving circuit as claimed in claim 10, wherein
in the reset phase, the reset scan signal has the second low voltage level; and
in the data-writing phase and the light enable phase, the reset scan signal has the high voltage level.

12. The light-emitting component driving circuit as claimed in claim 11, wherein
in the data-writing phase, the writing scan signal has the second low voltage level; and
in the reset phase and the light enable phase, the writing scan signal has the high voltage level.

13. The light-emitting component driving circuit as claimed in claim 3, wherein the data storage unit further comprises:
a writing transistor, having a gate receiving a writing scan signal, a drain receiving the data voltage, and a source coupled to the first drain/source of the driving transistor and the drain of the power conduction transistor; and
a collection transistor, having a gate receiving the writing scan signal, a source coupled to the gate of the driving transistor and the first end of the storage capacitor, and a drain coupled to the second drain/source of the driving transistor and the first end of the light-emitting component,
wherein the light-emitting component is an organic light-emitting diode, and the first end of the light-emitting component is an anode of the organic light-emitting diode, and the second end of the light-emitting component is a cathode of the organic light-emitting diode,
wherein a level of the reference voltage is substantially not less than a highest level of the data voltage minus the threshold voltage of the driving transistor and a conduction voltage of the organic light-emitting diode.

14. The light-emitting component driving circuit as claimed in claim 13, wherein the data storage unit further initializes the storage capacitor in response to a reset scan signal in a reset phase.

15. The light-emitting component driving circuit as claimed in claim 14, wherein the data storage unit further comprises:
a reset transistor, having a gate and a source coupled with each other to receive the reset scan signal, and a drain coupled to the gate of the driving transistor, the source of the collection transistor and the first end of the storage capacitor.

16. The light-emitting component driving circuit as claimed in claim 15, wherein the driving transistor, the power conduction transistor, the writing transistor, the collection transistor and the reset transistor are all P-type transistors.

17. The light-emitting component driving circuit as claimed in claim 16, wherein the light-emitting component driving circuit is an organic light-emitting diode driving circuit, and the organic light-emitting diode driving circuit sequentially enters the reset phase, the data-writing phase and the light enable phase.

18. The light-emitting component driving circuit as claimed in claim 17, wherein
in the reset phase and the data-writing phase, the variable power supply voltage has a first low voltage level; and
in the light enable phase, the variable power supply voltage has a high voltage level.

19. The light-emitting component driving circuit as claimed in claim 18, wherein
in the reset phase and the data-writing phase, the light enable signal has the high voltage level; and
in the light enable phase, the light enable signal has a second low voltage level different to the first low voltage level.

20. The light-emitting component driving circuit as claimed in claim 19, wherein
in the reset phase, the reset scan signal has the second low voltage level; and
in the data-writing phase and the light enable phase, the reset scan signal has the high voltage level.

21. The light-emitting component driving circuit as claimed in claim 20, wherein
in the data-writing phase, the writing scan signal has the second low voltage level; and
in the reset phase and the light enable phase, the writing scan signal has the high voltage level.

22. The light-emitting component driving circuit as claimed in claim 1, wherein a second end of the light-emitting component is coupled to a reference voltage, the power supply voltage is a constant power supply voltage, and the power unit comprises:
a power conduction transistor, having a source receiving the constant power supply voltage, and a gate receiving the light enable signal.

23. The light-emitting component driving circuit as claimed in claim 22, wherein
a first drain/source of the driving transistor is coupled to a drain of the power conduction transistor, a second drain/source of the driving transistor is coupled to the first end of the light-emitting component, and a gate of the driving transistor is coupled to the first end of the storage capacitor;
the second end of the storage capacitor is coupled to the constant power supply voltage through a first switching transistor; and
the second end of the storage capacitor is further coupled to the reference voltage through a second switching transistor.

24. The light-emitting component driving circuit as claimed in claim 23, wherein
a gate of the first switching transistor receives the light enable signal, a source of the first switching transistor is coupled to the constant power supply voltage, and a drain of the first switching transistor is coupled to the second end of the storage capacitor; and
a gate of the second switching transistor receives a complementary signal of the light enable signal, a source of the second switching transistor is coupled to the reference voltage, and a drain of the second switching transistor is coupled to the second end of the storage capacitor.

25. The light-emitting component driving circuit as claimed in claim 24, wherein the data storage unit further comprises:
a writing transistor, having a gate receiving a writing scan signal, a drain receiving the data voltage, and a source coupled to the second drain/source of the driving transistor and the first end of the light-emitting component; and
a collection transistor, having a gate receiving the writing scan signal, a source coupled to the gate of the driving transistor and the first end of the storage capacitor, and a drain coupled to the first drain/source of the driving transistor and the drain of the power conduction transistor,
wherein the light-emitting component is an organic light-emitting diode, and the first end of the light-emitting component is an anode of the organic light-emitting diode, and the second end of the light-emitting component is a cathode of the organic light-emitting diode,
wherein a level of the reference voltage is substantially not less than a highest level of the data voltage minus a conduction voltage of the organic light-emitting diode.

26. The light-emitting component driving circuit as claimed in claim 25, wherein the data storage unit further initializes the storage capacitor in response to a reset scan signal in a reset phase.

27. The light-emitting component driving circuit as claimed in claim 26, wherein the data storage unit further comprises:
a reset transistor, having a gate and a source coupled with each other to receive the reset scan signal, and a drain coupled to the gate of the driving transistor, the source of the collection transistor and the first end of the storage capacitor.

28. The light-emitting component driving circuit as claimed in claim 27, wherein the driving transistor, the power conduction transistor, the first switching transistor, the second switching transistor, the writing transistor, the collection transistor and the reset transistor are all P-type transistors.

29. The light-emitting component driving circuit as claimed in claim 28, wherein the light-emitting component driving circuit is an organic light-emitting diode driving circuit, and the organic light-emitting diode driving circuit sequentially enters the reset phase, the data-writing phase and the light enable phase.

30. The light-emitting component driving circuit as claimed in claim 24, wherein the data storage unit further comprises:
a writing transistor, having a gate receiving a writing scan signal, a drain receiving the data voltage, and a source coupled to the first drain/source of the driving transistor and the drain of the power conduction transistor; and
a collection transistor, having a gate receiving the writing scan signal, a source coupled to the gate of the driving transistor and the first end of the storage capacitor, and a drain coupled to the second drain/source of the driving transistor and the first end of the light-emitting component,
wherein the light-emitting component is an organic light-emitting diode, and the first end of the light-emitting component is an anode of the organic light-emitting diode, and the second end of the light-emitting component is a cathode of the organic light-emitting diode,
wherein a level of the reference voltage is substantially not less than a highest level of the data voltage minus the threshold voltage of the driving transistor and a conduction voltage of the organic light-emitting diode.

31. The light-emitting component driving circuit as claimed in claim 30, wherein the data storage unit further initializes the storage capacitor in response to a reset scan signal in a reset phase.

32. The light-emitting component driving circuit as claimed in claim 31, wherein the data storage unit further comprises:
a reset transistor, having a gate and a source coupled with each other to receive the reset scan signal, and a drain coupled to the gate of the driving transistor, the source of the collection transistor and the first end of the storage capacitor.

33. The light-emitting component driving circuit as claimed in claim 32, wherein the driving transistor, the power conduction transistor, the first switching transistor, the second switching transistor, the writing transistor, the collection transistor and the reset transistor are all P-type transistors.

34. The light-emitting component driving circuit as claimed in claim 33, wherein the light-emitting component driving circuit is an organic light-emitting diode driving circuit, and the organic light-emitting diode driving circuit sequentially enters the reset phase, the data-writing phase and the light enable phase.

35. The light-emitting component driving circuit as claimed in claim 1, wherein a second end of the light-emitting component is coupled to a reference voltage, the power supply voltage is a constant power supply voltage or a variable power supply voltage, and the power unit comprises:
a power conduction transistor, having a drain receiving the constant or the variable power supply voltage, and a gate receiving the light enable signal.

36. The light-emitting component driving circuit as claimed in claim 35, wherein
a drain of the driving transistor is coupled to a source of the power conduction transistor, a source of the driving transistor is coupled to the first end of the light-emitting component, and a gate of the driving transistor is coupled to a first end of the storage capacitor; and
a second end of the storage capacitor is coupled to the reference voltage.

37. The light-emitting component driving circuit as claimed in claim 36, wherein the data storage unit further comprises:
a writing transistor, having a gate receiving a writing scan signal, a drain receiving the data voltage, and a source coupled to the source of the driving transistor and the first end of the light-emitting component; and
a collection transistor, having a gate receiving the writing scan signal, a drain source coupled to the gate of the driving transistor and the first end of the storage capacitor, and a source coupled to the drain of the driving transistor and the source of the power conduction transistor,
wherein the light-emitting component is an organic light-emitting diode, and the first end of the light-emitting component is an anode of the organic light-emitting diode, and the second end of the light-emitting component is a cathode of the organic light-emitting diode,
wherein a level of the reference voltage is substantially not less than a highest level of the data voltage minus a conduction voltage of the organic light-emitting diode.

38. The light-emitting component driving circuit as claimed in claim 37, wherein the data storage unit further initializes the storage capacitor in response to a reset scan signal in a reset phase.

39. The light-emitting component driving circuit as claimed in claim 38, wherein the data storage unit further comprises:
a reset transistor, having a gate and a drain coupled with each other to receive the reset scan signal, and a source coupled to the gate of the driving transistor, the drain of the collection transistor and the first end of the storage capacitor.

40. The light-emitting component driving circuit as claimed in claim 39, wherein the driving transistor, the power conduction transistor, the writing transistor, the collection transistor and the reset transistor are all N-type transistors.

41. The light-emitting component driving circuit as claimed in claim 40, wherein the light-emitting component driving circuit is an organic light-emitting diode driving circuit, and the organic light-emitting diode driving circuit sequentially enters the reset phase, the data-writing phase and the light enable phase.

42. The light-emitting component driving circuit as claimed in claim 41, wherein
when the power supply voltage is the constant power supply voltage, the constant power supply voltage has a high voltage level; and
when the power supply voltage is the variable power supply voltage, the variable power supply voltage has a first low voltage level in the reset phase and the data-writing phase, and the variable power supply voltage has the high voltage level in the light enable phase, wherein a level of the reference voltage is substantially not less than the first low voltage level of the variable power supply voltage in the reset phase and the data-writing phase.

43. The light-emitting component driving circuit as claimed in claim 42, wherein
in the reset phase and the data-writing phase, the light enable signal has a second low voltage level different to the reference voltage and the first low voltage level; and
in the light enable phase, the light enable signal has the high voltage level.

44. The light-emitting component driving circuit as claimed in claim 43, wherein
in the reset phase, the reset scan signal has the high voltage level; and
in the data-writing phase and the light enable phase, the reset scan signal has the second low voltage level.

45. The light-emitting component driving circuit as claimed in claim 44, wherein
in the data-writing phase, the writing scan signal has the high voltage level; and
in the reset phase and the light enable phase, the writing scan signal has the second low voltage level.

46. A light-emitting component driving circuit, comprising:
a power unit, receiving a power supply voltage, and transmitting the power supply voltage in response to a light enable signal in a light enable phase;
a driving unit, coupled between the power unit and a first end of a light-emitting component, comprising a driving transistor coupled to the first end of the light-emitting component, and controlling a driving current flowing through the light-emitting component in the light enable phase; and
a data storage unit, comprising a storage capacitor, and storing a data voltage and a threshold voltage related to the driving transistor through the storage capacitor in a data-writing phase,
wherein in the light enable phase, the driving unit generates the driving current flowing through the light-emitting component in response to a cross voltage of the storage capacitor, and the driving current is not influenced by the power supply voltage and the threshold voltage of the driving transistor,
wherein a second end of the light-emitting component is coupled to a reference voltage, and a level of the reference voltage is substantially not less than a highest level of the data voltage minus a conduction voltage of the light-emitting component.

47. The light-emitting component driving circuit as claimed in claim 46, wherein
the light-emitting component is an organic light-emitting diode, and the first end of the light-emitting component is an anode of the organic light-emitting diode, and the second end of the light-emitting component is a cathode of the organic light-emitting diode, and
the light-emitting component driving circuit is an organic light-emitting diode driving circuit.

48. A light-emitting component driving circuit, comprising:
a power unit, receiving a power supply voltage, and transmitting the power supply voltage in response to a light enable signal in a light enable phase;
a driving unit, coupled between the power unit and a first end of a light-emitting component, comprising a driving transistor coupled to the first end of the light-emitting component, and controlling a driving current flowing through the light-emitting component in the light enable phase; and
a data storage unit, comprising a storage capacitor, and storing a data voltage and a threshold voltage related to the driving transistor through the storage capacitor in a data-writing phase,
wherein in the light enable phase, the driving unit generates the driving current flowing through the light-emitting component in response to a cross voltage of the storage capacitor, and the driving current is not influenced by the power supply voltage and the threshold voltage of the driving transistor,
wherein a second end of the light-emitting component is coupled to a reference voltage, and a level of the reference voltage is substantially not less than a highest level of the data voltage minus the threshold voltage of the driving transistor and a conduction voltage of the light-emitting component.

49. The light-emitting component driving circuit as claimed in claim 48, wherein
the light-emitting component is an organic light-emitting diode, and the first end of the light-emitting component is an anode of the organic light-emitting diode, and the second end of the light-emitting component is a cathode of the organic light-emitting diode, and
the light-emitting component driving circuit is an organic light-emitting diode driving circuit.

50. A pixel circuit, comprising:
a light-emitting component, lighting in response to a driving current in a light enable phase;
a power unit, receiving a power supply voltage, and transmitting the power supply voltage in response to a light enable signal in the light enable phase;
a driving unit, coupled between the power unit and a first end of the light-emitting component, comprising a driving transistor coupled to the first end of the light-emitting component, and controlling the driving current flowing through the light-emitting component in the light enable phase; and
a data storage unit, comprising a storage capacitor, and storing a data voltage and a threshold voltage related to the driving transistor through the storage capacitor in a data-writing phase,
wherein in the light enable phase, the driving unit generates the driving current flowing through the light-emitting component in response to a cross voltage of the storage capacitor, and the driving current is not influenced by the power supply voltage and the threshold voltage of the driving transistor,
wherein a second end of the light-emitting component is coupled to a reference voltage, and a level of the reference voltage is substantially not less than a highest level of the data voltage minus a conduction voltage of the light-emitting component.

51. The pixel circuit as claimed in claim 50, wherein
the light-emitting component is an organic light-emitting diode, and the first end of the light-emitting component is an anode of the organic light-emitting diode, and the second end of the light-emitting component is a cathode of the organic light-emitting diode, and
the pixel circuit is an organic light-emitting diode pixel circuit.

52. An organic light-emitting diode display panel having the pixel circuit as claimed in claim 51.

53. An organic light-emitting diode display having the organic light-emitting diode display panel as claimed in claim 52.

54. A pixel circuit, comprising:
a light-emitting component, lighting in response to a driving current in a light enable phase;
a power unit, receiving a power supply voltage, and transmitting the power supply voltage in response to a light enable signal in the light enable phase;
a driving unit, coupled between the power unit and a first end of the light-emitting component, comprising a driving transistor coupled to the first end of the light-emitting component, and controlling the driving current flowing through the light-emitting component in the light enable phase; and
a data storage unit, comprising a storage capacitor, and storing a data voltage and a threshold voltage related to the driving transistor through the storage capacitor in a data-writing phase,
wherein in the light enable phase, the driving unit generates the driving current flowing through the light-emitting component in response to a cross voltage of the storage capacitor, and the driving current is not influenced by the power supply voltage and the threshold voltage of the driving transistor,
wherein a second end of the light-emitting component is coupled to a reference voltage, and a level of the reference voltage is substantially not less than a highest level of the data voltage minus the threshold voltage of the driving transistor and a conduction voltage of the light-emitting component.

55. The pixel circuit as claimed in claim 54, wherein
the light-emitting component is an organic light-emitting diode, and the first end of the light-emitting component is an anode of the organic light-emitting diode, and the second end of the light-emitting component is a cathode of the organic light-emitting diode, and
the pixel circuit is an organic light-emitting diode pixel circuit.

56. An organic light-emitting diode display panel having the pixel circuit as claimed in claim 55.

57. An organic light-emitting diode display having the organic light-emitting diode display panel as claimed in claim 56.
